(19) United States
(12) Patent Application Publication
(10) Pub. No.: US 2007/0092360 A1
(43) Pub. Date: Apr. 26, 2007

(54) Reciprocating cart type assembly line system using linear motor

(76) Inventor: Gyeong-Won Joo, Ulsan Metropolitan City (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/257,202

(22) Filed: Oct. 24, 2005

(51) Int. Cl. B65F 9/00; B23K 37/02

(52) U.S. Cl. 414/373; 219/86.7

(57) ABSTRACT

A cart type assembly line system in which a cart unit loads and moves a work to an outer group unit for processing the work includes a linear motor for moving the cart unit on a moving path. A first cart rail guides the cart unit on the path. A cart jig of the cart unit, and an outer jig at the outer group unit are further provided for restricting the work, wherein if the cart jig ascends to restrict the work and moves to the outer group unit, the outer jig restricts the work. Then, the cart jig releases the restriction of the work, descends, and withdraws from the outer group unit. Under this configuration, the number of cart units and the installation area of the system are reduced by using the reciprocating motion of the cart units in a straight line.

### CROSS-REFERENCE TO RELATED APPLICATIONS

The present application is based on, and claims priority from, Korean Application Serial Number 10-2004-0028321, filed on Apr. 23, 2004, the disclosure of which is hereby incorporated by reference herein in its entirety.

### FIELD OF THE INVENTION

The present invention relates to an assembly line system in which cart units restrict, move and process a work piece (e.g., a component of the vehicle body assembly or the like). More particularly, the present invention relates to a cart type assembly line system adapted to reduce the number of cart units required in the assembly line system and the installation area of the total assembly line system by the reciprocating motion of the cart units along a line.

### BACKGROUND OF THE INVENTION

The conventional cart type assembly line systems used in the vehicle plant are equipped with a plurality of cart units moving along the assembly line according to the multi-processing. The cart units are loaded first on a cart return line and then supplied onto a process line.

However, the process line and return line are typically arranged in at least two stories, thus increasing the number of cart units due to the extended circulating path, requiring a wide return line, and complicating the installation configuration of the system. Furthermore, as the carts are moved by cart conveyors driven by chains, a large amount of noise is produced.

### SUMMARY OF THE INVENTION

Embodiments of the present invention are provided to reduce the number of cart units and the installation area thereof, thereby enabling to properly use a cart type assembly line system even for a small production. Embodiments of the present invention is further provided to reciprocate the cart units in a straight line, thus removing the cart return line and reducing the number of cart units required on the line. Noise can also be reduced by moving via a non-contact linear motor if desired.

A cart type assembly line system according to an exemplary embodiment of the invention in which a cart unit loads and moves a work piece to an outer group unit and the outer group unit processes the work includes a linear motor that provides the force to move the cart unit on a path between a loading position, where the cart unit loads the work piece, and a processing position, where a process is performed by the outer group unit. A first cart rail guides the cart unit on the moving path. A cart jig is provided at the cart unit for restricting the work piece and ascending and descending. An outer jig is provided at the outer group unit for restricting the work and ascending and descending. If the cart jig of the cart unit ascends to restrict the work piece and move to the outer group unit, the outer jig restricts the work piece. Then, the cart jig releases the restriction of the work, descends, and withdraws from the outer group unit.

A replacing position may further be provided between the loading position and processing position for the replacement of the cart unit. Loading spaces may be formed at both sides of the replacing position for loading the cart unit. A second cart rail connects the loading spaces and replacing position. A linear motor allows the cart unit to move between the loading spaces and replacing position for the exchange of various types of the cart unit.

### BRIEF DESCRIPTION OF THE DRAWINGS

For a better understanding of the nature and objects of the present invention, reference should be made to the following detailed description with the accompanying drawings, in which:

FIG. 1a is a schematic view of a cart type assembly line system using linear motors according to an embodiment of the present invention;

FIG. 1b illustrates a configuration of a cart unit and outer group unit according to an embodiment of the present invention;

FIGS. 2a to 2g illustrate the states of the cart unit and outer group unit in each processing step according to an embodiment of the present invention; and

FIG. 3 is a schematic view of a cart replacing method in the cart type assembly line system using linear motors according to an embodiment of the present invention.

### DETAILED DESCRIPTION OF THE PREFERRED EMBODIMENTS

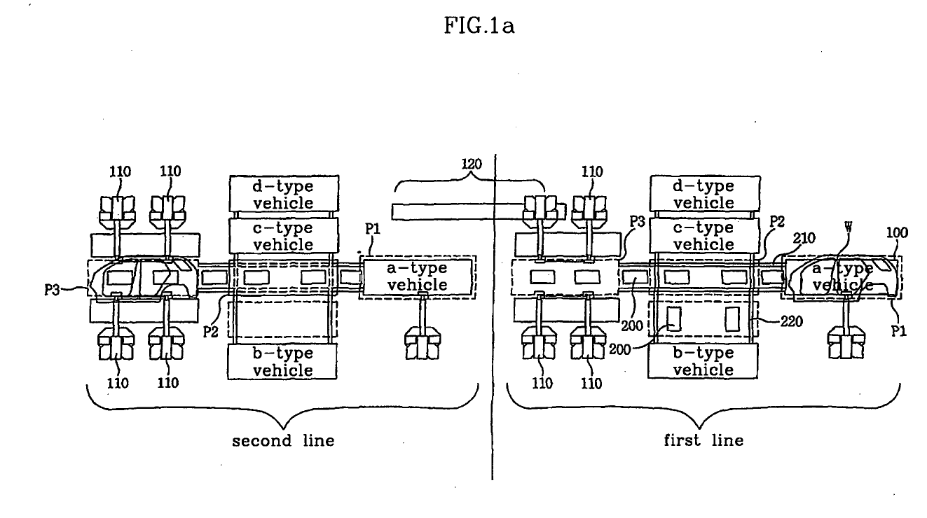

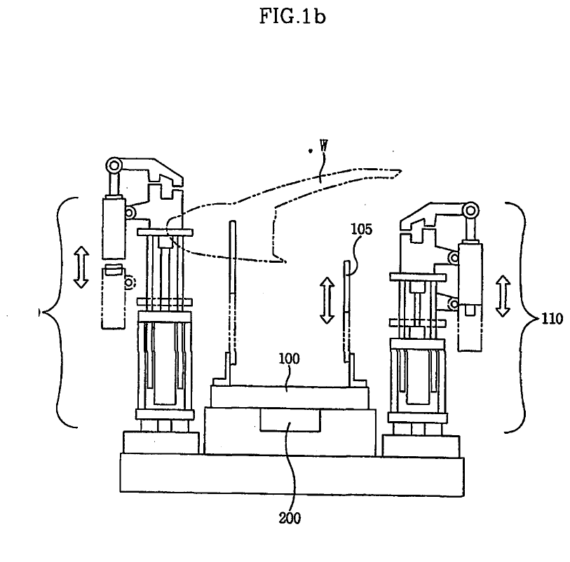

Referring to FIG. 1a, a cart type assembly line system according to an embodiment of the present invention includes a cart unit 100 that reciprocates between a loading position (P1), where a work piece (W) is loaded at cart unit 100, and a processing position (P3), where the work piece is processed by an outer group unit 110, through a replacing position (P2) located in the middle of the loading position (P1) and processing position (P3).

Linear motors 200 (generating force that converts electric energy into linear kinetic energy so that when the motor is provided with the power, the magnetic field moves in a straight line to generate thrust), which provide thrust to shift cart unit 100, are arranged along the bottom from the loading position (P1) to processing position (P3), and a first cart rail 210, together with linear motors 200, is formed to guide the moving path of cart unit 100.

The process of the present invention is executed as cart unit 100 moves in the direction from the right to the left in the drawing, and the first and second lines have identical configurations. The lines illustrated in the drawing are coupled to form the overall line of the present invention. When the process at the first line is completed, the work piece moves to the loading position (P1) of the second line via a transport means 120 and undergoes the process of the second line.

In the cart type assembly line system, a device is required to replace the cart in various types; and the present invention is equipped with a device that can replace four types of carts.

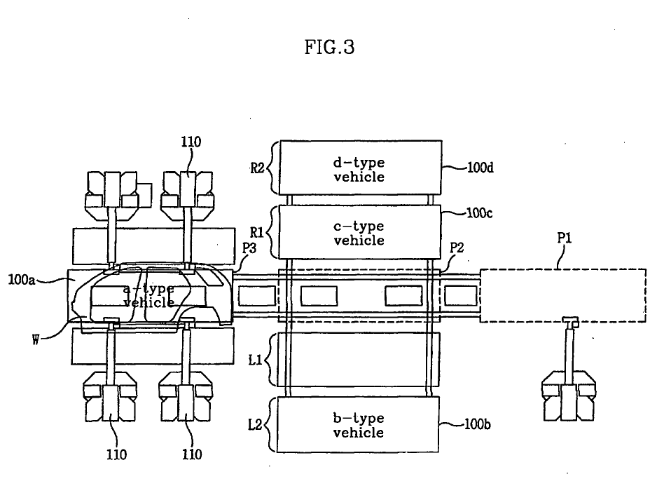

Therefore, the replacing position (P2) is provided between the loading position (P1) and processing position (P3), and both sides of the replacing position (P2) are loaded with carts for the sake of the replacement. The detailed explanation of the above portion will be described later with FIG. 3.

Cart unit 100 of FIG. 1b restricts and moves the work piece (W) while linearly reciprocating between the loading position (P1) and processing position (P3). In order to restrict the work piece (W), a cart jig 105 vertically ascending and descending is further provided. The linear reciprocation of cart unit 100 is performed via the linear motors. Outer group unit 110, receiving the work from cart unit 100 and performing the process, is equipped with operation units for performing the process with an outer jig. The operation units can preferably move vertically or laterally to perform a prescribed process, and the outer jig, again, controls the work piece (W) fixed to the cart jig even after the cart jig is withdrawn.

The operation of the unit at each processing step will be described below.

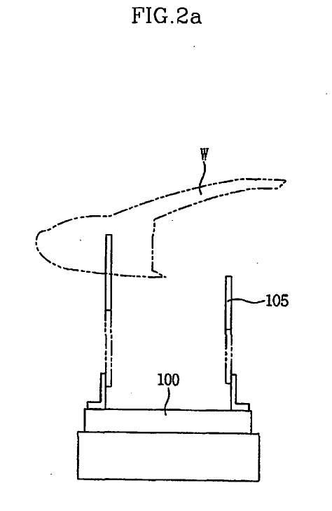

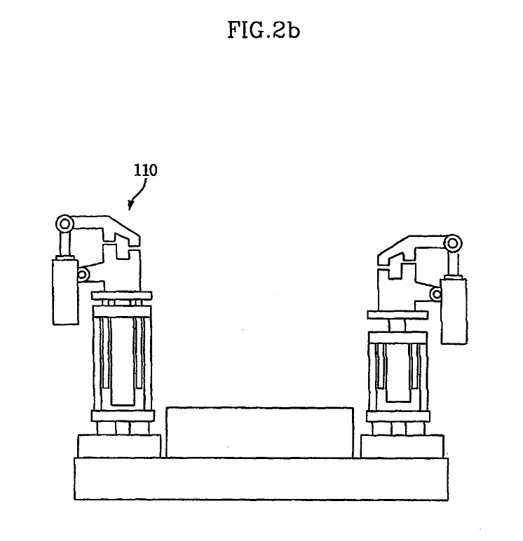

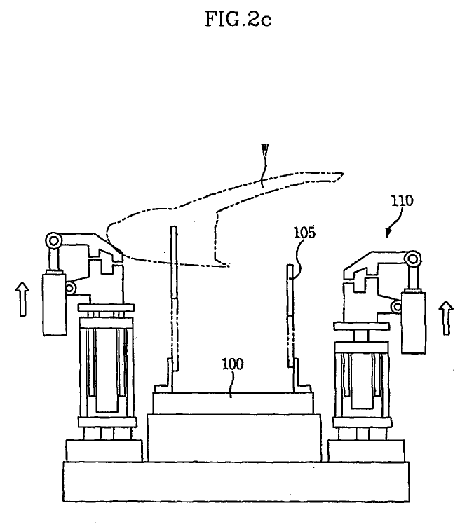

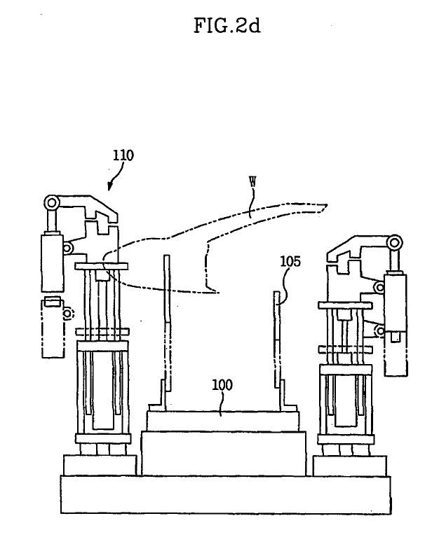

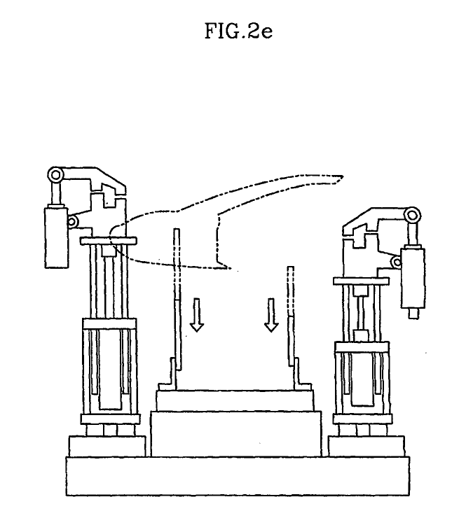

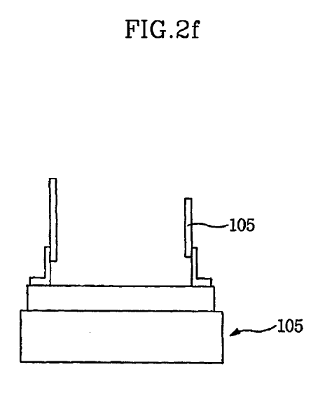

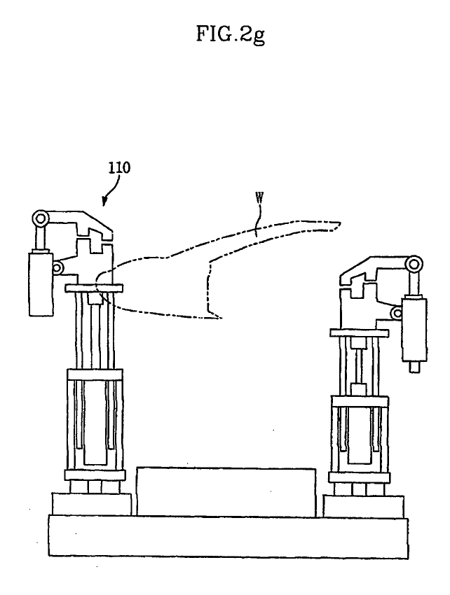

As illustrated in FIG. 2a, cart jig 105 of cart unit 100 fixes the work piece (W) during its ascended state at the loading position (P1). The work piece (W), however, is not placed at the desired position. The units of outer group unit 110 retain their descended states as shown in FIG. 2b. Cart unit 100 passes through the replacing position (P2) and reaches to the processing position (P3) (see FIG. 2c).

Referring now to FIG. 2d, when cart unit 100 is determined to enter into the processing position (P3), the units of outer group unit 110 are lifted and arranged on a coordinate identical to that of cart unit 100. The outer jigs of outer group unit 110, again, restrict the work piece (W), then place the work piece (W) to the desired position. If the outer jigs completely restrict the work piece, cart jig 105 of cart unit 100 releases the restriction of the work piece (W) and descends (see FIG. 2e). Even if cart jig 105 withdraws, the work (W) maintains the fixed state via the outer jigs; therefore, the process via outer group unit 110 can be performed. During the descended state of the cart jig as illustrated in FIG. 2f, cart unit 100 recedes to the processing position (P3). Then, the cart jig ascends, moves to the loading position (P1), and loads, again, another work piece (W) just like FIG. 2a. While the work is restricted as shown in FIG. 2g, outer group unit 110 performs a welding process or the like. The processing work by outer group unit 110 starts after cart unit 100 is disposed on the processing position (P3) and restricted in the desired position. The processing work continues until the work is completed regardless of the withdrawal of cart unit 100.

Before the withdrawal of cart unit 100, the process is executed at where no interference occurs with cart unit 100, and after cart unit 100 withdraws, the process is continuously carried out at the remaining sections to complete the processing work.

Hereinafter, the cart replacing structure according to the present invention will be described.

The assembly line system of the present invention is configured to have the replacing position (P2) between the loading position (P1) and processing position (P3). The replacing position (P2) is formed at both sides thereof with two cart loading spaces, respectively. Hence, the total of four cart units, including one that is on the line, is provided.

The replacing method of the cart unit will be described with reference to FIG. 3.

In reference to the drawing, each cart unit contains different types of vehicles, and four vehicle types can be accommodated in the present invention.

In order to replace a B-type vehicle cart unit 100b placed at the L2 loading space after an A-type vehicle cart unit 100a finishes the assembly work, B-type vehicle cart unit 100b is shifted to the replacing position (P2) and then to the loading position (P1) while A-type vehicle cart unit 100a is positioned at the processing position (P3). Next, A-type vehicle cart unit 100a is moved to the replacing position (P2) and to the L1 loading space to complete the cart unit replacement.

The cart units move by the operation of the linear motors aligned at the bottom thereof. On the process line (P1, P2, and P3), the cart units move along first rail 210. At the loading spaces, the cart units move between R2, R1, P2, L1, and L2 along second cart rail 220. As a result, a rail switching device is mounted at the replacing position (P2) for regulating the connected state of the first or second cart rail. The rail switching unit is, however, identical in structure to that of the traditional train system so that the detailed description will be omitted.

In case of replacing the A-type vehicle to a D-type vehicle, a C-type vehicle cart unit, placed at the R1 loading space, is moved to the L1 loading space while A-type vehicle cart unit 100a is located at the processing position (P3). A D-type vehicle cart unit 100d is shifted onto the loading position (P1) through the replacing position (P2). If A-type vehicle cart unit 100a is moved to the R2 loading space through the replacing position (P2), the replacement of unit is finished.

As apparent from the foregoing, there is an advantage in that the cart units of the present cart type assembly line system reciprocate in a straight line for transporting the works, thereby removing the cart return line, and greatly reducing the installation area and cost thereof. Furthermore, the cart of the present invention is moved by non-contact linear motors, thus reducing noise.

As the installation area and cost thereof are extremely reduced, the cart type assembly line system of the present invention can also be applied to a small production line system.

What is claimed is:

1. A cart type assembly line system in which a cart unit loads and moves a work piece to an outer group unit and the outer group unit processes the work piece, the system comprising:
a linear motor for moving the cart unit on a path between a loading position, where the cart unit loads the work piece, and a processing position, where a process is performed by the outer group unit;
a first cart rail for guiding the cart unit on said path;
a cart jig provided at the cart unit for restricting the work piece and ascending and descending; and
an outer jig provided at the outer group unit for restricting the work piece and ascending and descending, wherein if said cart jig of the cart unit ascends to restrict the work piece and moves to the outer group unit, said outer jig restricts the work piece, and then said cart jig releases the restriction of the work piece, descends and withdraws from the outer group unit.

2. The system as defined in claim 1, further comprising:
a replacing position between said loading position and processing position for replacement of the cart unit;
loading spaces at both sides of said replacing position for loading the cart unit;
a second cart rail that connects said loading spaces and replacing position; and
a linear motor that allows the cart unit to move between said loading spaces and replacing position so as to replace said cart unit in accordance with vehicle types.

3. The system as defined in claim 2, wherein both sides of said replacing position are formed with at least two loading spaces.

4. A cart type assembly line system, comprising:
a cart unit configured to load and move a work piece between a loading position and a processing position, said cart unit powered by a linear motor and including a cart jig for restricting the work piece;
an outer group unit configured to perform a process on the work piece at the processing position and including an outer jig for restricting the work piece; and
at least a first cart rail defining at least in part a path between the loading position and the processing position, said at least first cart rail guiding the cart unit;
wherein said cart jig and outer jig are configured and dimensioned for ascending and descending in cooperation such that when the cart jig ascends to restrict the work piece and moves to the outer group unit the outer jig restricts the work piece and then the cart jig releases the work piece, descends and withdraws from the outer group unit.

5. The system as defined in claim 4, further comprising:
a replacing position between said loading position and processing position for replacement of the cart unit;
loading spaces at both sides of said replacing position for loading the cart unit;
a second cart rail that connects said loading spaces and replacing position; and
a linear motor that allows the cart unit to move between said loading spaces and replacing position so as to replace said cart unit in accordance with vehicle types.

6. The system as defined in claim 5, wherein both sides of said replacing position are formed with at least two loading spaces.
